(19) United States
(12) Patent Application Publication
(10) Pub. No.: US 2014/0297431 A1
(43) Pub. Date: Oct. 2, 2014

(54) System and Method for Providing an Online Discount

(71) Applicant: Michael Catania, Tallahassee, FL (US)

(72) Inventor: Michael Catania, Tallahassee, FL (US)

(21) Appl. No.: 13/852,681

(22) Filed: Mar. 28, 2013

(51) Int. Cl. G06Q 30/02

(52) U.S. Cl. CPC G06Q 30/0277
USPC 705/14.73

(57) ABSTRACT

A method of implementing a computer readable program code on a computer network by providing an online discount to a user in order to access a coupon code for a business. The method provides a local server and a business server that are connected to a computer network. The business server provides a link which can he selected by a user. The local server provides a database containing data relating to coupon codes, including the codes themselves, expiration dates and other text or images. The user selects the link and the data is accessed from the local server and displayed on a target document to the user. The activity of the user is monitored in the target document and an online program manager allows a business to monitor and update the target document.

### CROSS-REFERENCES TO RELATED APPLICATIONS

This application is a non-provisional application claiming priority to U.S. Provisional Application No. 61/616,635 filed on Mar. 28, 2012.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of a computer-implemented method to assist an e-commerce business' relationship with online shoppers to facilitate online sales. More specifically, the present invention comprises a method and system for allowing an online shopper to search and secure an online coupon without navigating away from a website, while permitting an online retailer to monitor and control their online coupons through a third party.

2. Description of the Related Art

Electronic retailing or “e-commerce” is rapidly expanding in popularity. Retailers around the world have active websites wherein a user can both shop and purchase a multitude of products and services online as opposed to entering a physical location. From a user/shopper standpoint, e-commerce eliminates the hassle and time of getting to and from a store to purchase items. From a retailer standpoint, an e-commerce site is a low-cost alternative to setting up a retail location or a low-maintenance supplement to its existing physical location.

The advent of e-commerce has led to a new system and culture in which consumers and businesses operate. In the new system, marketing, selling, advertising and purchasing differs from traditional methods. One example is the ever-increasing usage of online coupons. Online coupons often consist of a simple alphanumeric code, which is entered by a consumer upon “check out” on a website. The code permits the consumer to take advantage of discounts that the retailer offers; for example, free shipping specials or a reduction in price of the purchased products. The codes can be e-mailed to a consumer, posted online by the retailer, handed out on cards at physical locations or events, or provided in advertisements on other websites. Additionally, there are currently many third-party websites that offer searchable online databases for consumers to view codes relating to thousands of e-commerce websites.

E-commerce businesses hoping to encourage users to visit and purchase from their websites often work with these third party sites which offer “code databases.” This is often accomplished through affiliate marketing. Online affiliate marketing typically involves an e-commerce business engaging an affiliate directly or through an affiliate network. E-commerce businesses compensate the affiliates and networks by paying them commissions. While there are many methods for determining when a commission shall be paid, one common method is based on a percentage of each purchase made by a customer directed to an e-commerce site from an affiliate's site. An e-commerce business may pay a significant percentage of each sale to an affiliate.

Thus, a consumer may search online for a particular coupon or discount and be directed to an affiliate web site by a search engine. When that consumer clicks on a link on the affiliate site he is directed to the e-commerce business' website, and the affiliate receives a commission based on sales made following the re-direction. The common practice is for a consumer to go directly to an e-commerce business' website to purchase a product. When this occurs the user may add a product to the shopping cart and proceed to the “check out.” During the check out process common graphic user interfaces offer an input box for an online coupon code. Typically, upon seeing the code input box, a consumer will open a new browser window to search for an online code to use. As discussed above, third party sites exist on which a user can search by business name for online codes to input. There are several problems with this process, both for the consumer and the business. First, a consumer who navigates away from an e-commerce business' site, even to find a relevant coupon, is more likely to become distracted either by content on the new web page or some intervening event, which frequently results in the loss of a sale. This phenomenon is commonly referred to as “cart abandonment.” Another problem results from consumers finding and using online coupon codes that are not valid, often due to expiration. This causes consumer frustration and dissatisfaction with the buyer's purchasing experience. However, because the consumer was redirected from the affiliate web site an affiliate commission is still paid where there has been a purchase even though the affiliate web site didn't provide a code used during the purchase.

Therefore what is needed is (1) a system and method that provides an e-commerce business site with a reliable and efficient way to allow a consumer to make an online purchase using a valid coupon code without having to navigate away from the business' web site and (2) a system and method that allows e-commerce businesses to monitor and efficiently update their codes via a third party website.

### BRIEF DESCRIPTION OF THE SEVERAL VIEWS OF THE DRAWINGS

FIG. 1 is a flow chart, showing the present invention.

FIG. 2 is a flow chart, showing the step of providing the user with the online discount.

FIG. 3 is a flow chart, showing the step of alerting the business that the online discount was accessed.

FIG. 4 is a schematic view, showing the hardware and software components of the present invention.

FIG. 5 is a screen shot, showing the e-commerce business' check out cart.

FIG. 6 is a screen shot, showing the online discount list displayed to the user.

FIG. 7 is a screen shot, showing the sign on screen for the online program manager system.

FIG. 8 is a screen shot, showing the user interface providing a summary page.

FIG. 9 is a screen shot, showing the user interface wherein new online coupon codes can be added.

FIG. 10 is a screen shot, showing the user interface wherein the online coupon codes can be managed.

FIG. 11 is a screen shot, showing the user interface wherein the e-commerce business manager can control the settings of the online coupon code management.

FIG. 12 is a screen shot showing messages from the provider to the online e-commerce business.

FIG. 13 is a screen shot, showing a live preview of the active coupons.

FIG. 14 is a screen shot, showing a simplified user interface for initiating contact to the third party affiliate provider.

### REFERENCE NUMERALS IN THE DRAWINGS

| | | | |
|---|---|---|---|
| 10 | computer program product | 12 | business server |
| 14 | processor | 16 | local server |
| 18 | processor | 20 | use |
| 22 | cookie | 24 | link |
| 26 | database | 28 | graphical user interface |
| 30 | user computing device | 32 | web browser |
| 34 | shopping cart | 36 | item |
| 38 | code data input | 40 | target document |
| 42 | sign in graphical user interface | 44 | welcome graphical user |
| | | | interface |
| 46 | notices | 48 | media links |
| 50 | functional user interface | 52 | data input |
| 54 | icon | 56 | coupon code |

### DETAILED DESCRIPTION OF INVENTION

The present method and system is a computer program product 10 for allowing a user to search and secure an online coupon or coupon code without navigating away from a web-site, while permitting a e-commerce business (retailer) to monitor and control the online coupons through a third party.

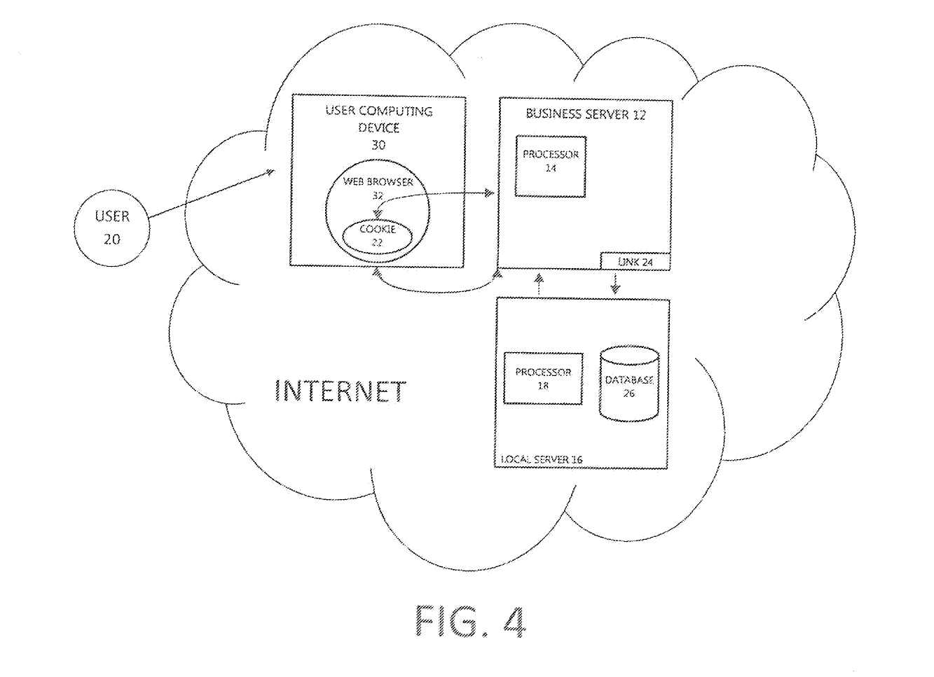

FIG. 4 represents the hardware and software components of the present method. As illustrated a first server, or business server 12, is shown having a processor 14. The second server, or local server 16, also is shown as having a processor 18. Both servers are connected to the internet. As further described below, the business server 12 interacts with the local server 16 in order to bring the user 20 information via the user's computing device 30. Local server 16 is preferably an online server operated by the program covered by the present system and method. As described herein it is desirable that a third party, hired by the retailer (business owner), controls and manages the execution of the program and the data stored on local server 16.

A web browser 32 (software application) stored on user's computing device allows the user to interact with the intern or “World Wide Web,” and thus, permits user interaction with business server 12 and local server 16. Business server 12 includes a link 24 which appears to the user on the graphical user interface as further described below. While link 24 can be any type of re-direction to a new document, it is preferable that link 24 causes a target document to open in a new window. Thus, the user, in effect, never navigates away from the site or business server 12. The link 24 accesses information from local server 16, bringing up a target document that shows the user information from database 26, located on local server 16. Database 26 provides data in the form of an online coupon list within the target document, such that the user can view and select choice coupons or codes. A cookie 22 is set by the business server for each user, when the user begins a session. The http cookie or web cookie interacts with the user's web browser 32 and stores text data on the user's computing device 30. Once stored, the cookie 22 can report the user's progress through the site. This data is reported back to the business server 12 and stored. It is preferable that the cookie 22 is a “session cookie” which is temporary and only lasts for the time period in which the user is using the target website. The web browser 32 would delete the cookie 22 when the user quits. While a session cookie is desirable, the current method could also use any other type of tracking cookie which evaluates the user's progress through the site.

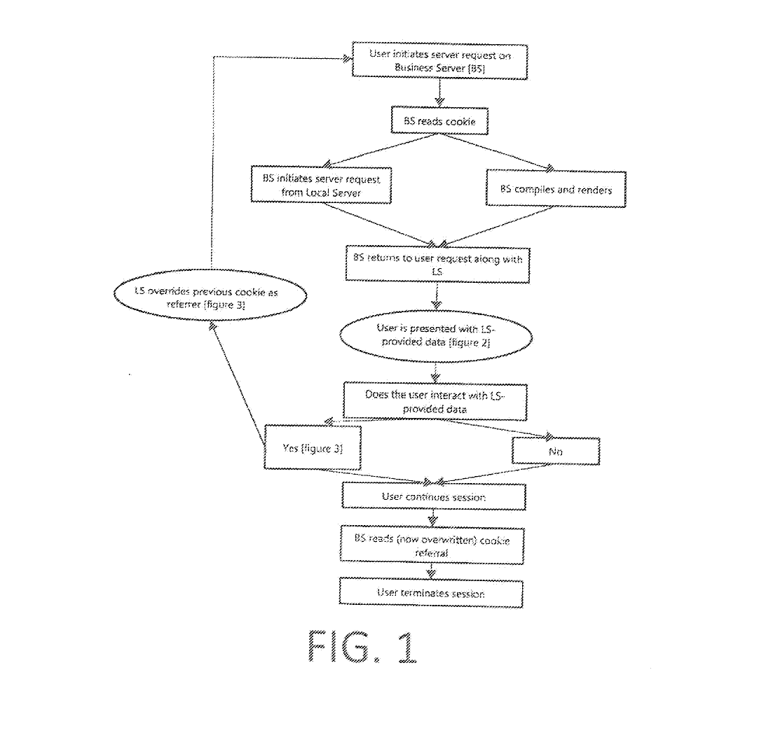

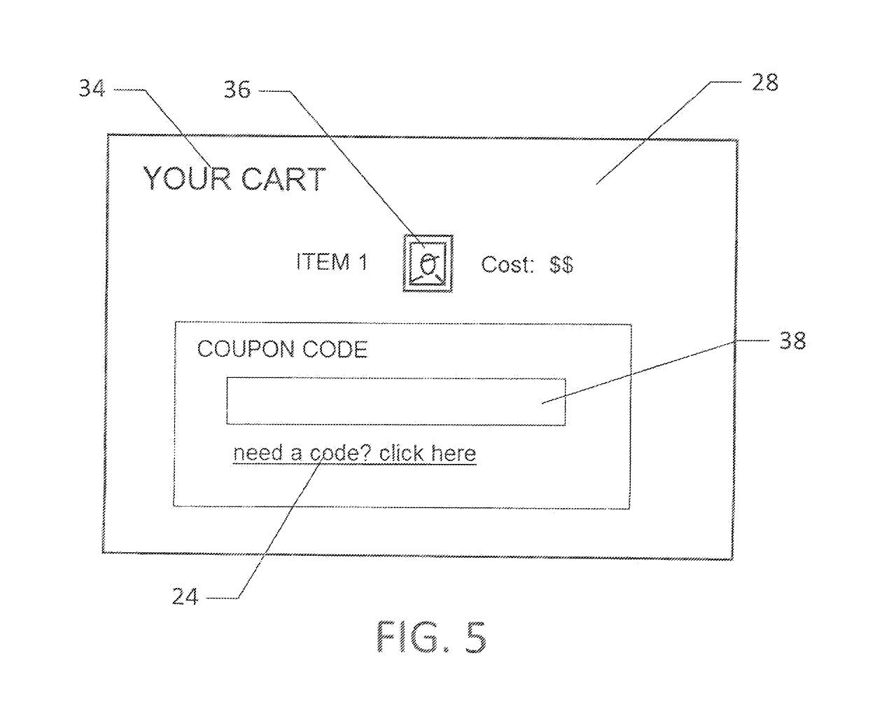

FIGS. 1, 2 and 3 are data flow diagrams illustrating the present method. As illustrated in FIG. 1, the user initiates a server request on the business server 12 via user's web browser 32 (illustrated in FIG. 4). Cookie 22 is created within the user's web browser 32 by an application within business server 12. Business server 12, prompted by the user's server request, compiles and renders internal data via a computer readable code which provides user with an interactive graphical user interface. A user can browse the e-commerce business website and add products, with the click of a mouse, to the user's shopping cart 34. FIG. 5 illustrates a simplified graphical user interface 28 where an item 36 has been added to the user's shopping cart 34. As illustrated in both FIG. 1 and FIG. 5, business server 12 provides link 24 to a third party site (local server 16) on graphical user interface 28. Link 24 can be displayed as specific language or an image which invites the user to engage with local server fed data. Link 24 is preferably located proximate to code data input 38, where a user would enter a code if the user had previously obtained a code.

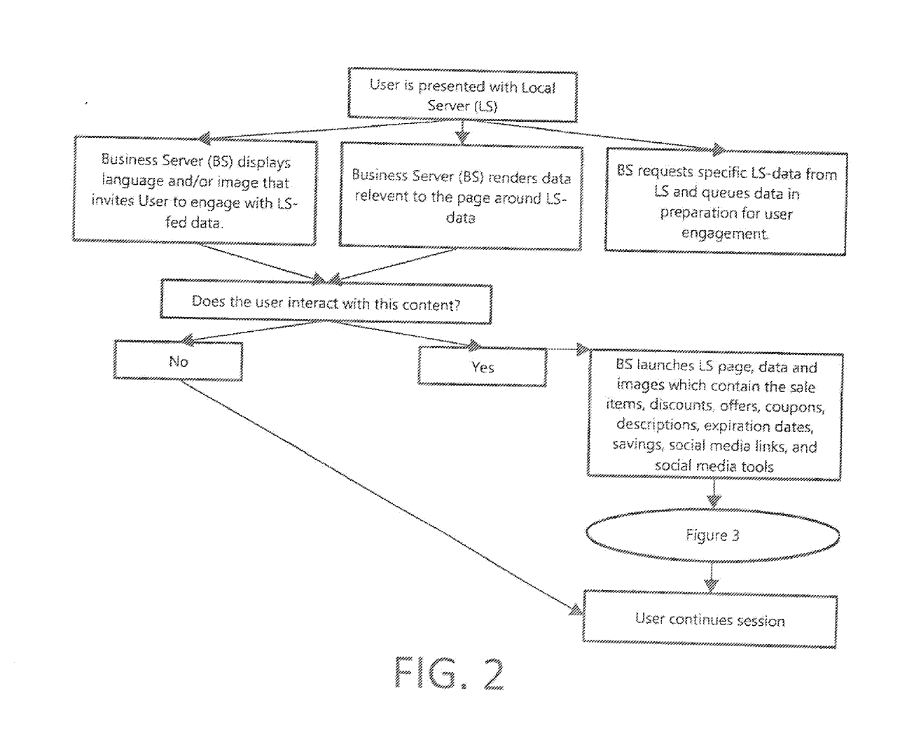

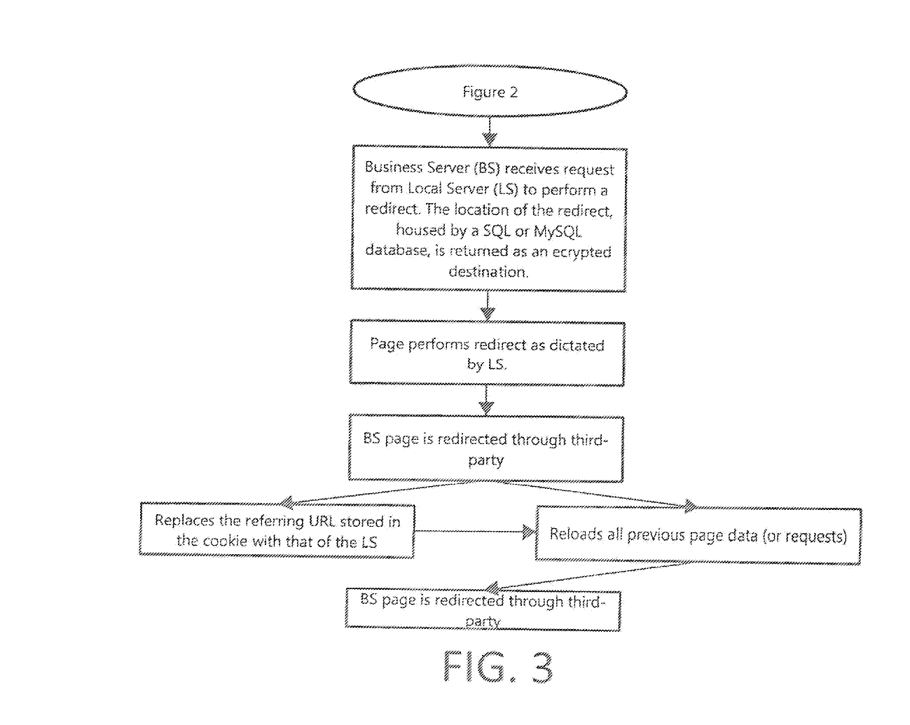

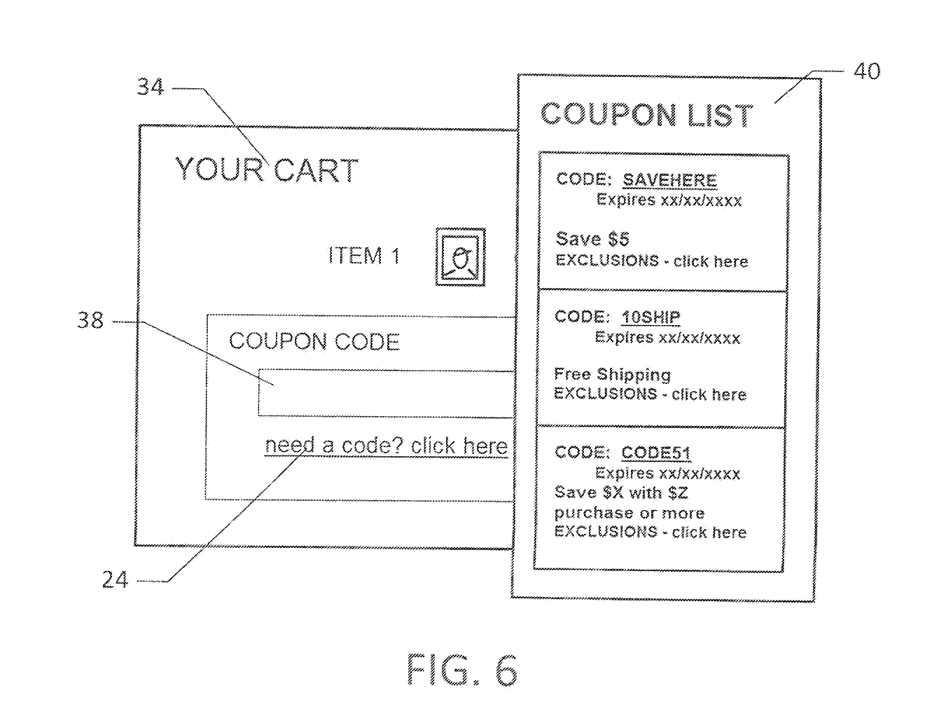

Upon activation of link 24 on business server 12, business server 12 initiates a server request from local server 16. As illustrated in FIG. 2, local server 16 presents user with relevant data to the web-page around the local server data. The business server 12 also request specific local server data from local server and queues the data in preparation for the user engagement. If the user activates link 24 the business server 12 launches the local server page, data, and images which can contain the sale items, discounts, offers, coupons, descriptions, expiration dates, savings, social media links and social media tools. FIG. 6 illustrates graphical user interface upon activation of link 24. A target document 40 opens in a new window, or “pop-up” window, displaying a list having data for the user. In the preferred embodiment, the list is comprised of “online coupons” having coupon codes 56, expiration dates, text regarding the discount and a link to any exclusions (if relevant), and any data relating to coupon discounts. Simultaneously to the “pop-up” window opening, the website displaying the “cart” (illustrated in FIG. 5) performs a redirect that pushes the existing cart page through the third party link 24 where the destination is again the cart page. This action tracks the action by the user of linking to the third party local server 16 (and thus, the local server data). In order to allow the third party (operating local server 16 and providing data to business server 12) to receive “credit” for the use of the data or coupon code 56, it is important that the business server 12 is able to monitor the “clicks” of the user. The business server system could either be directed to monitor the “clicks” of users on the link 24 or specifically on a coupon code 56. Thus, the third party or local server 16 would either get “credit” for use of the link 24 or only where a coupon code 56 provided by local server 16 was actually used by a user/consumer (clicked on to input into code data input 38). As described and illustrated further in the data flow diagram in FIG. 3, business server 12 receives a request from the local server 16 to perform a redirect (in the preferred embodiment, the simple “refresh” described above). The location of the redirect, housed by a SQL or MySQL database, is returned as an encrypted destination. The web-page performs a redirect as dictated by local server 16. The business server 12 is redirected through a third-party. Next, the web browser either replaces the referring URL stored in the cookie with that of the local server 16 and then reloads all previous page data (the “refresh”) or goes directly to reload all previous page data. Then the user continues the session. The business server reads the cookie referral data (now overwritten). Again, this allows the business to identify that the user utilized either the link provided by the third party or the coupon code 56 provided by the third party. Finally, the user terminates the session.

It is important to the present invention that local server 16 and business server 12 are two distinct components operated by two distinct entities. Due to the nature of the online environment, a third party operation of the coupon discount site is imperative in order to provide e-commerce businesses with the opportunity to continue to engage in the practice of affiliate marketing. Thus, the present method permits the e-commerce business to continue to utilize coupon codes through an affiliate marketing commission program but without the aforementioned detriment to the consumer and the e-commerce business.

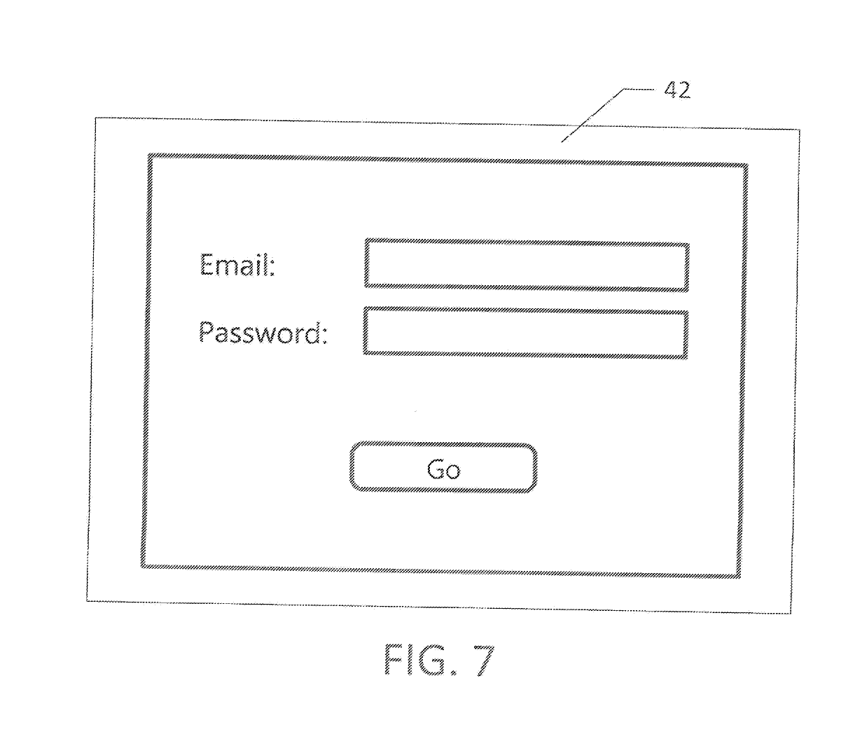

Additionally, the e-commerce business can easily and efficiently monitor the coupon codes provided by the third party affiliate. FIGS. 7-14 illustrate the final step of the method, which includes providing an online program manager system such that the e-commerce business administrator can access, control and monitor the discounts they offer. This access occurs via a non-downloadable program preferably stored on local server 16. FIG. 7 illustrates a “sign on” screen or sign in graphical user interface 42. The program provides for the storage of user names and passwords on a local database, such that each e-commerce business administrator can access their respective accounts.

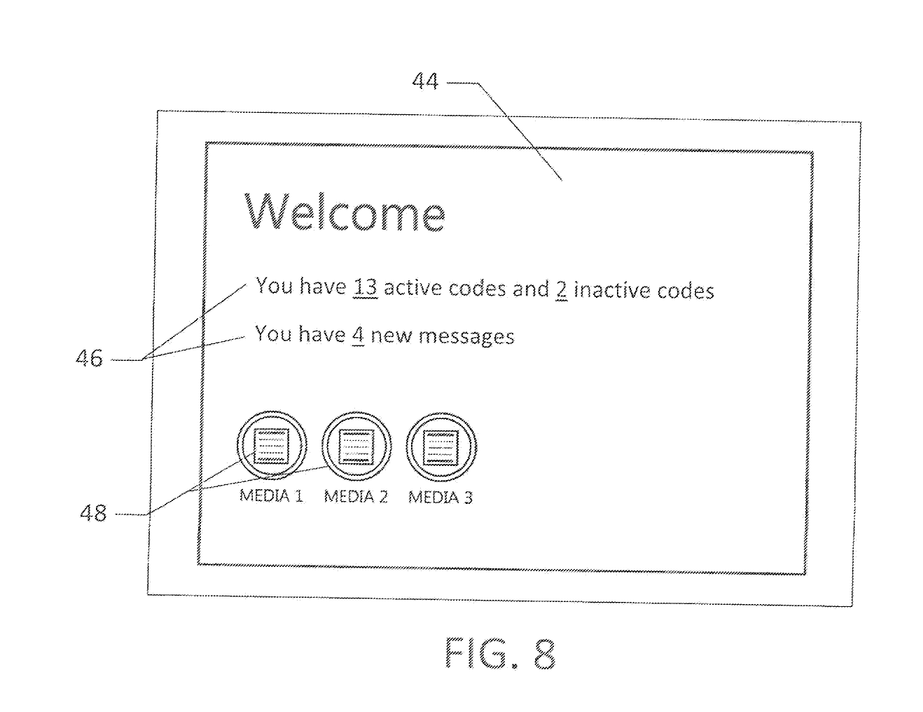

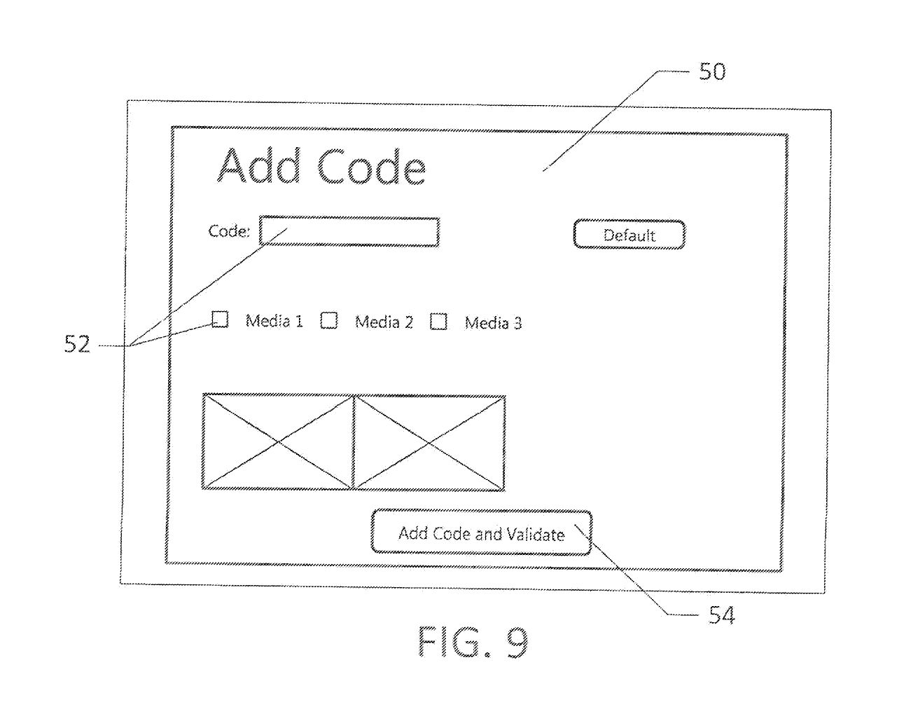

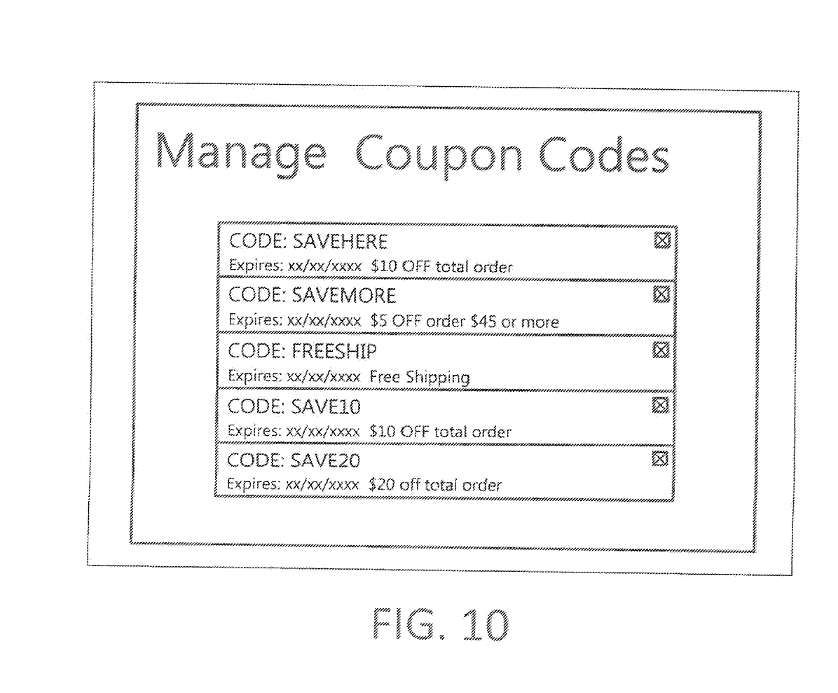

FIG. 8 is a sample graphical user interface showing a summary of the data and relationship with the third party affiliate, welcome graphical user interface 44. As illustrated the codes (active/inactive) are summarized in an alert 46. An alert 46 can also be provided which relates to new notifications. Additionally, the marketing efforts or media outlet of the third party affiliate is shown as media links 48. The alerts 46 and media links 48 provide a summary page for the online e-commerce business administrator viewing the page after sign in. The functional user interface 50 permitting the addition of a new coupon code 56 is illustrated in FIG. 9. The e-commerce business manager can add data and validate the data, specifying the relevant dates, the description, where to promote the coupon, etc. The interface is simple to use, is accurate, timely and provides for any relevant exclusions. The manager can add data in any known manner of data entry or input, however it is preferable that data inputs 52 are provided to enter a code name and the option to choose the media outlets desired to advertise or market the particular code. The manager can add the code and validate by clicking on code icon 54. Once the details of a coupon code 56 are added, it can be managed as illustrated in FIG. 10. The administrator can instantly change, delete or add the coupons, such that a user could access the data in real time. This allows for flash sales, up-sells and/or inventory reductions.

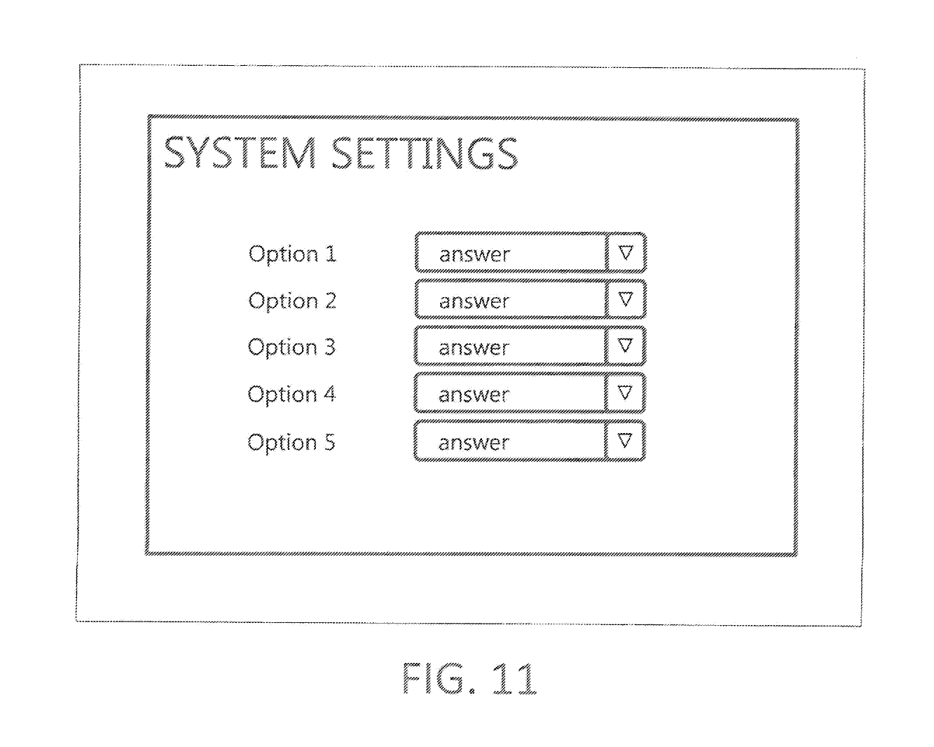

FIG. 11 is a screen shot showing a preferable method of offered system settings, which are primarily directed to providing the desired amount of communication from the third party affiliate, to the e-commerce business administrator. For example, some preferred system settings include providing the general time frame that the business offers coupons, whether notifications are requested upon expiration of a coupon and some options relating to the arrangement of the display that the user/consumer will ultimately view. For purposes of illustration the system settings are displayed as “options,” which would include an optional setting; and “answers,” which preferably include a drop down menu allowing the manager to set the preferred setting for each option.

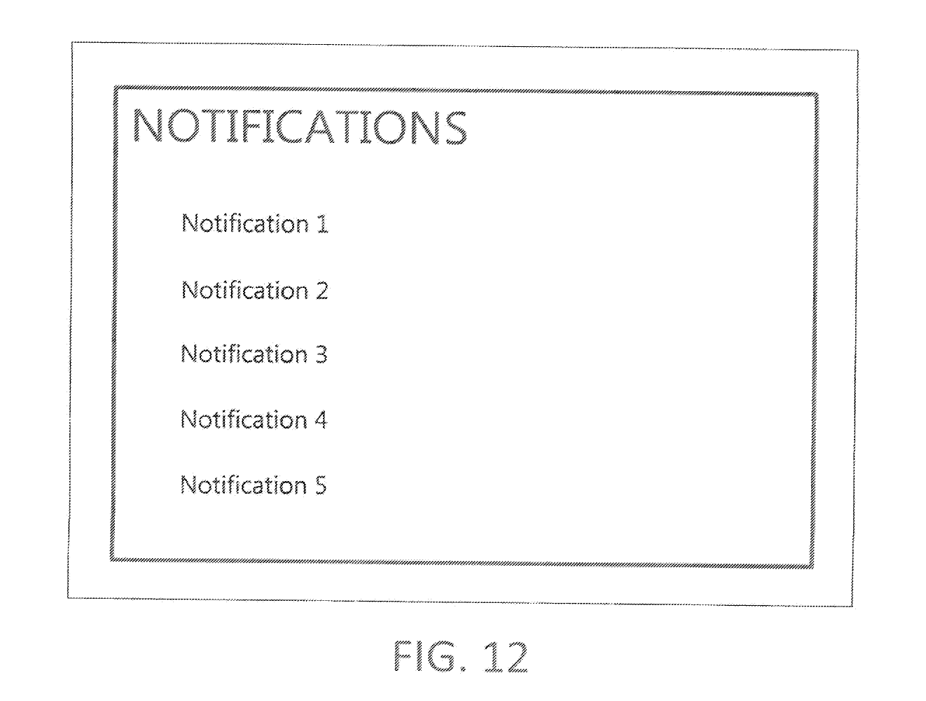

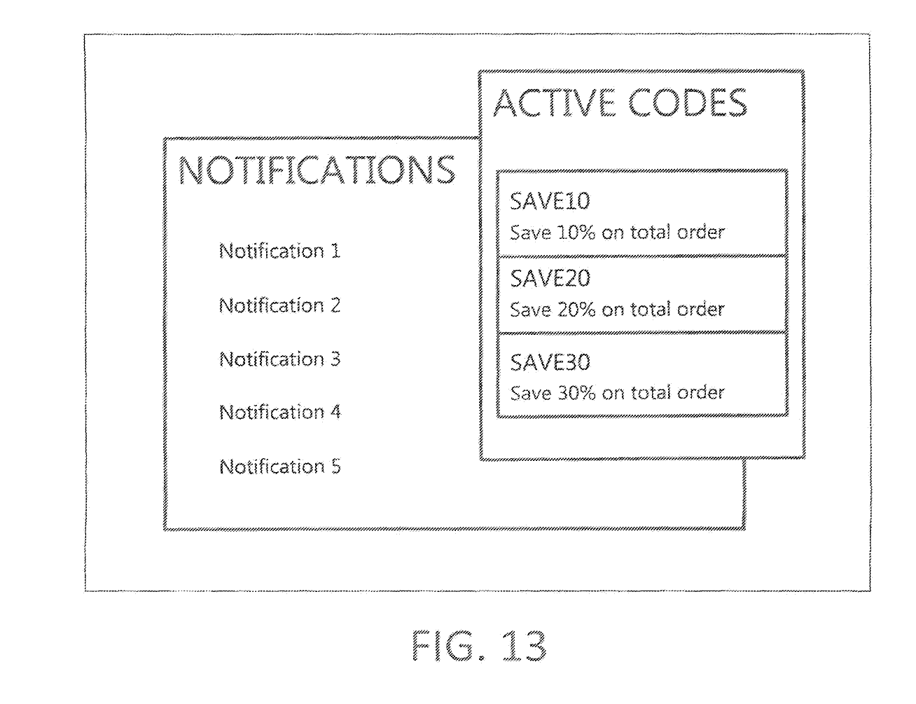

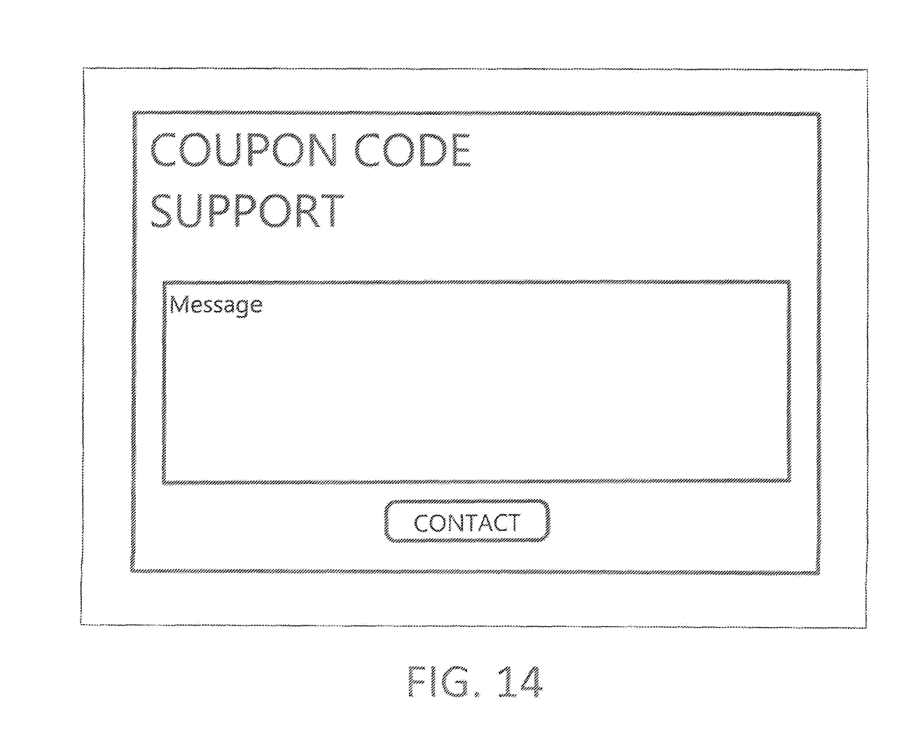

A screen shot illustrating a preferred method of providing notifications is shown in FIG. 12. While FIG. 13 provides a “live preview” of how the user/consumer will view the “pop up” screen including coupons or coupon codes on the e-commerce businesses' website. Finally, FIG. 14 illustrates a common user interface for initiating contact from the administrator to the third party affiliate.

The preceding description contains significant detail regarding the novel aspects of the present invention, it should not be construed, however, as limiting the scope of the invention but rather as providing illustrations of the preferred embodiments of the invention.

Having described my invention, I claim:

1. A computer program product, comprising a non-transitory computer usable medium having a computer readable program code embodied therein, said computer readable program code adapted to be executed to implement a method of providing an online discount to a user in order to access at least one coupon having at least one coupon code for a business, comprising the steps of:
a. providing a link on a graphical user interface to be stored on a business server;
b. providing a local server having a database containing data relating to said at least one coupon having said at least one coupon code;
c. allowing said user to select said link in order to access said data, wherein when selected said link directs said user to a target document;
d. displaying said data in the form of at least one coupon having said at least one coupon code on said target document;
e. monitoring said user interaction with said target document; and
f. providing an on-line program manager program wherein said business can monitor and update said data displayed on said target document.

2. The computer program product of claim 1, wherein said link causes said target document to open in a new window.

3. The computer program product of claim 1, further comprising the step of creating a cookie set by an application located on said business server for each user when said user begins a session.

4. The computer program product of claim 3, wherein said user has a web browser and said cookie interacts with said web browser of said user in order to collect a set of data.

5. The computer program product of claim 4, wherein said cookie is a session cookie.

6. The computer program product of claim 1, wherein said graphical interface further includes a code data input.

7. The computer program product of claim 6, wherein said link is located proximate to said code data input on said graphical user interface.

8. The computer program product of claim 1, wherein when said user selects said link, said business server tracks the selection of said link by said user.

9. The computer program product of claim 1, wherein said on-line program manager program is a non-downloadable program stored on said local server.

10. The computer program product of claim 1, further comprising the step of providing a live preview of said target document.

11. A method of implementing a non-transitory computer readable programmable code on a computer network, said non-transitory computer readable programmable code adapted to be executed to implement a method of providing an online discount to a user in order to access a plurality of coupon codes for a business having a business server, comprising the steps of:
a. providing a local server connected to said computer network and having a processor;
b. wherein said business server is:
i. connected to said computer network and has a processor; and
ii. provides a link on a graphical user interface;
c. wherein said local server has a database containing data relating to said plurality of said coupon codes;
d. wherein when said link is selected by said user, said link accesses said data from said local server and directs said user to a target document;
e. displaying said data in the form of said plurality of coupon codes on said target document;
e. monitoring said user interaction with said target document; and
f. providing an on-line program manager program wherein said business can monitor and update said data displayed on said target document.

12. The method of implementing a non-transitory computer readable programmable code on a computer network as recited in claim 11, wherein said link causes said target document to open in a new window.

13. The method of implementing a non-transitory computer readable programmable code on a computer network as recited in claim 11, further comprising creating a cookie set by an application on said business server for said user when said user begins a session.

14. The method of implementing a non-transitory computer readable programmable code on a computer network as recited in claim 13, wherein said user has a web browser and said cookie interacts with said web browser of said user in order to collect a set of data.

15. The method of implementing a non-transitory computer readable programmable code on a computer network as recited in claim 14, wherein said cookie is a session cookie.

16. The method of implementing a non-transitory computer readable programmable code on a computer network as recited in claim 11, wherein said graphical interface further includes a code data input.

17. The method of implementing a non-transitory computer readable programmable code on a computer network as recited in claim 11, wherein said data displayed on said target document includes said coupon codes, an expiration date, a series of text and a link to exclusions.

18. The method of implementing a non-transitory computer readable programmable code on a computer network as recited in claim 11, wherein when said user selects said link, said business server tracks the selection of said link by said user.

19. The method of implementing a non-transitory computer readable programmable code on a computer network as recited in claim 11, wherein said on-line program manager program is a non-downloadable program stored on said local server.

20. The method of implementing a non-transitory computer readable programmable code on a computer network as recited in claim 11, further comprising the step of providing a live preview of said target document.
